(19) United States
(12) Patent Application Publication
(10) Pub. No.: US 2011/0113866 A1
(43) Pub. Date: May 19, 2011

(54) Microengineered Supercritical Fluid Chromatography System

(76) Inventor: Alan Finlay, West Byfleet (GB)

(21) Appl. No.: 12/944,318

(22) Filed: Nov. 11, 2010

(30) Foreign Application Priority Data
Nov. 13, 2009 (GB) GB0919909.2

(51) Int. Cl. G01N 30/02; B01D 15/08; B01D 35/18; B23P 17/04; G01N 21/33; H01J 49/26

(52) U.S. Cl. 73/61.52; 210/198.2; 210/177; 137/15.01; 356/51; 250/281

(57) ABSTRACT

This invention describes a microengineered SFC system for rapidly and efficiently separating the constituents of a complex mixture. The SFC system includes a microchannel that is microfabricated from a suitable substrate so that it forms a chromatographic column for separation of chemicals. The surface area of the microchannel of the column is sufficiently small as to permit use of miniature and relatively inexpensive pumps, and the thermal mass of the microengineered column is sufficiently low as to permit rapid temperature cycling using a miniature, low power and inexpensive heating element. At least a portion of this microchannel is packed with suitable sorbent materials or includes surfaces which are suitably coated with sorbent, or both, so as to retain and elute analyte under certain conditions. As a result analyte passing within this microchannel undergoes chromatographic separation.

### CROSS-REFERENCE TO RELATED APPLICATIONS

This application claims the benefit of Great Britain Patent Application No. GB0919909.2 filed on Nov. 13, 2009.

### TECHNICAL FIELD OF THE INVENTION

The invention relates to a supercritical fluid chromatography device and systems incorporating such devices. The invention also relates to methodologies configured for chromatographic analysis of one or more analytes. In an exemplary arrangement the invention relates to the chromatographic devices comprising microfabricated components and their use in supercritical fluid chromatography systems.

### BACKGROUND OF THE INVENTION

Chromatography is an analytical technique used for the separation and purification of complex chemical mixtures into their constituent components. In supercritical fluid chromatography (SFC), the sample is dissolved and separated using a supercritical fluid, usually a high compressible gas, as a mobile phase. Typically, carbon dioxide (CO₂) is employed as the mobile phase. The fluid is held above its triple point and for this reason the entire flow path is pressurised. SFC is a type of normal phase chromatography that may be used for the purification and analysis of small molecules (i.e. less than 1,000 amu), polar and non-polar compounds, thermally labile, volatile and non-volatile compounds.

Compared with high performance liquid chromatography (HPLC), SFC provides rapid separations without the use of organic solvents and reduces waste disposal and solvent costs. Because SFC often uses CO₂, it contributes no new gases to the environments. Therefore SFC is considered a far more environmentally friendly process than HPLC.

SFC has been demonstrated to have superior speed and resolving power compared to traditional HPLC. Separations have been accomplished up to an order of magnitude faster than HPLC instruments using the same chromatographic columns. This is a consequence of the superior solubility and diffusion rates of solutes in mobile phases based on supercritical fluids. Because the viscosity of supercritical fluids is very low, the diffusion of solutes in supercritical fluids is about then times greater than in liquids. This results in decreased resistance to mass transfer in the chromatographic column and allows for fast separation with superior resolution. The lower viscosities of supercritical fluids relative to liquid solvents means that the pressure drop across a chromatographic column for a given flow rate is greatly reduced. The higher diffusion constant means that longer columns and higher analysis speeds are possible, and the higher density of the supercritical fluid means higher solubility and increased column loading is possible. Another advantage of SFC is that, compared with GC, capillary SFC can provide high resolution chromatography at much lower temperatures than GC, which permits rapid analysis of thermally labile compounds such as organic peroxides (e.g. HMTD, TATP), carbamates and pesticides. SFC is frequently used to separate chiral and achiral components using special columns.

The solvation strength of a supercritical fluid is directly related to its fluid density. Due to their high densities (e.g. 0.2-0.5 gm/cm³), supercritical fluids are capable of dissolving large, non-volatile molecules. Solids can become highly soluble in the presence of a supercritical fluid for example, and SFC has been employed to separate polymers, to extract caffeine from coffee beams and nicotine from tobacco. Another advantage of SFC is that analytes may be recovered quickly from solution by simply allowing the supercritical fluid to evaporate, leaving only analyte and no solvent. This makes collection of fractions straightforward. For these reasons, SFC is finding applications in the fractionation of oils, polymer chemistry, environmental and food analysis.

There are a number of possible fluids which may be used in SFC as the mobile phase. However, supercritical CO₂ is the preferred fluid in SFC because it is inexpensive, non-toxic, non-flammable and has a relatively low critical temperature and pressure (T_{c}=31.3° C., P=72.9 atm). The main disadvantage of carbon dioxide is its inability to elute very polar or ionic compounds. An organic solvent is frequently added as a polar modifier at a concentration of a few tens of percentages. This is generally an organic fluid which is completely miscible with carbon dioxide (alcohols, cyclic ethers) but can be almost any liquid including water. The organic solvent modifier adjusts the polarity of the mobile phase for optimum chromatographic performance.

The addition of the modifier fluid improves the solvating ability of the supercritical fluid and sometimes enhances selectivity of the separation. It can also help improve separation efficiency by blocking some of the highly active sites on the stationary phase. For that reason modifier fluids are commonly used in packed column SFC. Both ‘open’ capillary and packed columns have been demonstrated with SFC instruments, and organic modifier can make a difference to column performance. Since different compounds require different concentrations of organic modifier to elute rapidly, a common technique is to continuously vary the composition of the mobile phase by linearly increasing the organic modifier concentration.

The main components of a conventional SFC system are shown in FIG. 1. A pump 101 draws on a reservoir of a suitable supercritical fluid (e.g. CO₂) 105. The fluid 105 may already be stored in its supercritical state, or may be transformed into its supercritical state by the pump 101 and the pressurised flow path. The pump 101 may be a reciprocating pump or simple syringe or infusion pump. For a packed column reciprocating pumps are typically used, and for capillary columns syringe pumps are more typical. A combination of both is possible, as is a hybrid of a capillary and packed column. The function of the pump 101 is to provide a controlled pressure to the flow path so that the fluid is in supercritical state. The pressure may be controlled from the pump 101 or from the flow restrictor 107, or some combination of the two, so that elution of analytes may occur in order of solubility. The pump 101 is frequently cooled by a cooling element 110 to ensure the fluid is in a liquid state when pumped into the flow path. A sample injection mechanism 102 may include valves and sample loops and injects sample 106 into the flow path and onto a chromatographic column 103. The sample injection mechanism 102 may also provide means to infuse an organic modifier to adjust the polarity of the fluid. The column 103 may be a packed column or a capillary column, so some hybrid of both, and is typically heated by an oven or suitable heating element 104 to maintain the fluid in its supercritical state in the column 103 and upstream of the flow restrictor 107. The flow restrictor 107 may be placed either upstream or downstream of the detector 108, and its function is to maintain an appropriate pressure upstream of the restrictor to ensure that fluid is maintained in a supercritical state in the column 103. The flow restrictor 107 may be a fixed capillary or nozzle or orifice of defined length and diameter, or a mechanically regulated constriction, orifice or nozzle that is used to control pressure in the column 103. Likewise the pump 101 may be used to control the pressure across the column. The column 103 is usually mounted inside an oven or heating element 104 that maintains the fluid in the flow path in a supercritical state. Typically, GC or LC ovens are employed. The analyte elutes from the column 103 into a detector 108. The detect 108 may be a flame ionisation detector (FID), a UV detector, photodiode array (PDA) or mass spectrometer (MS) or some other typical GC or LC detector. The detector 108 is typically placed upstream of the flow restrictor 107 if it is a UV, PDA, MS detector or other typical LC-type detector, and downstream if it is a FID or GC-type detector. The flow restrictor 107 or detector 108 then usually vents analyte and solvent to atmosphere at a vent or to a fraction collector 109.

Part of the theory of separation in SFC is based on the density of the supercritical fluid which corresponds to solvating power. As the pressure in the system is increased, the supercritical fluid density increases and correspondingly its solvating power increases. Therefore, as the density of the supercritical fluid mobile phase is increased, components retained in the column can be made to elute in order of the inverse solubility. This is similar to temperature programming in gas chromatography (GC) or using a solvent gradient in high performance liquid chromatography (HPLC). Supercritical fluid chromatography can most easily be described as a variant of either HPLC or GC where the major modification is the replacement of either the liquid or gas mobile phase with a supercritical fluid mobile phase. In general there are two hardware setups used: (a) An HPLC-like setup with two reciprocating pumps designed to provide a mixed mobile phase with a packed analytical column placed in an oven followed by an optical detector in which the pressure and flow rates can be independently controlled, (b) A GC-like setup with a syringe pump followed by a capillary column in a GC oven with a restrictor followed by a flame ionization detector, where the pressure is controlled by the flow rate of the pump.

With reference to FIG. 1, the mobile phase is initially pumped as a liquid and is brought into the supercritical region by heating it above its supercritical temperature before it enters the analytical column. It passes through an injection valve where the sample is introduced into the supercritical stream and then into the analytical column. For packed SFC, a typical LC injection valve is commonly used. In capillary SFC, small sample volumes must be quickly injected into the column and therefore pneumatically driven valves are used. It is maintained supercritical as it passes through the column and into the detector by a pressure restrictor placed either after the detector or at the end of the column. The restrictor allows the pressure to be controlled independently of the flow rate. The restrictor is a vital component as it keeps the mobile phase supercritical throughout the separation and often must be heated to prevent clogging; both variable and fixed restrictors are available. The most critical component in a modern SFC is the backpressure regulator or restrictor. This provides an additional control parameter—pressure. The restrictor is sometimes a pressure-adjustable diaphragm or controlled nozzle.

Although SFC instruments are similar to HPLC instruments, unlike HPLC an oven is generally used to provide temperature control of the column and a restrictor or back pressure regulator is used to maintain pressure in the column. The ovens used in SFC are generally conventional GC or LC ovens.

In contrast to HPLC pumping, pressure rather than flow control is necessary and pulseless operation is desirable. The type of high-pressure pump used is determined by the column type. For packed columns, reciprocating pumps are generally used while for capillary columns, syringe pumps are often used. Reciprocating pumps allow easy mixing of the mobile phase and introduction of modifier fluids. Syringe pumps provide consistent pressure for the mobile phase. The flow rate should be kept as constant as possible through the column. If the flow rate fluctuates, variations in the retention time of the injected sample would occur. Pumps are frequently cooled to maintain the supercritical fluid in a liquid state.

Once the sample is injected into the supercritical stream it is carried into the analytical column. The column contains a highly viscous liquid (called a stationary phase) into which the analytes can be temporarily adsorbed and then released based on their chemical nature. This temporary retention causes some analytes to remain longer in the column and is what allows the separation of the mixture. Different types of stationary phases are available with varying compositions and polarities. There are two types of analytical columns used in SFC, packed and capillary. Packed columns contain small deactivated particles to which the stationary phase adheres. The columns are conventionally stainless steel. Capillary columns are open tubular columns of narrow internal diameter made of fused silica, with the stationary phase bonded to the wall of the column

SFC is compatible with both HPLC and GC detectors. As a result, optical detectors, flame detectors, and spectroscopic detectors can be used. However, the mobile phase composition, column type, and flow rate must be taken into account when the detector is selected as they will determine which detector is able to be used. Some care must also be taken such that the detector components are capable of withstanding the high pressures of SFC. SFC may also be used with mass spectrometer (MS) detectors. Whereas flame ionisation detectors (FID) produce constant background noise in the presence of an organic modifier, MS does not.

Recent increases in solvent costs, acute solvent shortages and increased awareness of environmental factors have driven renewed interest in ‘green’ analytical technologies such as SFC. While macroscopic SFCs are available commercially, are greener, generate virtually no waste and use little or no solvent, and offer performance that is comparable if not superior to HPLCs, their size and cost is significant and may be limiting their uptake by users.

### SUMMARY OF THE INVENTION

Chromatography is an analytical technique used for the separation and purification of complex chemical mixtures into their constituent components. In supercritical fluid chromatography (SFC), the sample is dissolved and separated using a supercritical fluid, usually a high compressible gas, as a mobile phase. Typically, carbon dioxide (CO₂) is employed as the mobile phase. The fluid is held above its triple point and for this reason the entire flow path is pressurised. SFC is a type of normal phase chromatography that may be used for the purification and analysis of small molecules (i.e. less than 1,000 amu), polar and non-polar compounds, thermally labile, volatile and non-volatile compounds.

Compared with high performance liquid chromatography (HPLC), SFC provides rapid separations without the use of organic solvents and reduces waste disposal and solvent costs. Because SFC often uses CO₂, it contributes no new gases to the environments. Therefore SFC is considered a far more environmentally friendly process than HPLC.

SFC has been demonstrated to have superior speed and resolving power compared to traditional HPLC. Separations have been accomplished up to an order of magnitude faster than HPLC instruments using the same chromatographic columns. This is a consequence of the superior solubility and diffusion rates of solutes in mobile phases based on supercritical fluids. Because the viscosity of supercritical fluids is very low, the diffusion of solutes in supercritical fluids is about then times greater than in liquids. This results in decreased resistance to mass transfer in the chromatographic column and allows for fast separation with superior resolution. The lower viscosities of supercritical fluids relative to liquid solvents means that the pressure drop across a chromatographic column for a given flow rate is greatly reduced. The higher diffusion constant means that longer columns and higher analysis speeds are possible, and the higher density of the supercritical fluid means higher solubility and increased column loading is possible. Another advantage of SFC is that, compared with GC, capillary SFC can provide high resolution chromatography at much lower temperatures than GC, which permits rapid analysis of thermally labile compounds such as organic peroxides (e.g. HMTD, TATP), carbamates and pesticides. SFC is frequently used to separate chiral and achiral components using special columns.

The solvation strength of a supercritical fluid is directly related to its fluid density. Due to their high densities (e.g. 0.2-0.5 gm/cm³), supercritical fluids are capable of dissolving large, non-volatile molecules. Solids can become highly soluble in the presence of a supercritical fluid for example, and SFC has been employed to separate polymers, to extract caffeine from coffee beams and nicotine from tobacco. Another advantage of SFC is that analytes may be recovered quickly from solution by simply allowing the supercritical fluid to evaporate, leaving only analyte and no solvent. This makes collection of fractions straightforward. For these reasons, SFC is finding applications in the fractionation of oils, polymer chemistry, environmental and food analysis.

There are a number of possible fluids which may be used in SFC as the mobile phase. However, supercritical CO₂ is the preferred fluid in SFC because it is inexpensive, non-toxic, non-flammable and has a relatively low critical temperature and pressure (T_{c}=31.3° C., P=72.9 atm). The main disadvantage of carbon dioxide is its inability to elute very polar or ionic compounds. An organic solvent is frequently added as a polar modifier at a concentration of a few tens of percentages. This is generally an organic fluid which is completely miscible with carbon dioxide (alcohols, cyclic ethers) but can be almost any liquid including water. The organic solvent modifier adjusts the polarity of the mobile phase for optimum chromatographic performance.

The addition of the modifier fluid improves the solvating ability of the supercritical fluid and sometimes enhances selectivity of the separation. It can also help improve separation efficiency by blocking some of the highly active sites on the stationary phase. For that reason modifier fluids are commonly used in packed column SFC. Both ‘open’ capillary and packed columns have been demonstrated with SFC instruments, and organic modifier can make a difference to column performance. Since different compounds require different concentrations of organic modifier to elute rapidly, a common technique is to continuously vary the composition of the mobile phase by linearly increasing the organic modifier concentration.

The main components of a conventional SFC system are shown in FIG. 1. A pump 101 draws on a reservoir of a suitable supercritical fluid (e.g. CO₂) 105. The fluid 105 may already be stored in its supercritical state, or may be transformed into its supercritical state by the pump 101 and the pressurised flow path. The pump 101 may be a reciprocating pump or simple syringe or infusion pump. For a packed column reciprocating pumps are typically used, and for capillary columns syringe pumps are more typical. A combination of both is possible, as is a hybrid of a capillary and packed column. The function of the pump 101 is to provide a controlled pressure to the flow path so that the fluid is in supercritical state. The pressure may be controlled from the pump 101 or from the flow restrictor 107, or some combination of the two, so that elution of analytes may occur in order of solubility. The pump 101 is frequently cooled by a cooling element 110 to ensure the fluid is in a liquid state when pumped into the flow path. A sample injection mechanism 102 may include valves and sample loops and injects sample 106 into the flow path and onto a chromatographic column 103. The sample injection mechanism 102 may also provide means to infuse an organic modifier to adjust the polarity of the fluid. The column 103 may be a packed column or a capillary column, so some hybrid of both, and is typically heated by an oven or suitable heating element 104 to maintain the fluid in its supercritical state in the column 103 and upstream of the flow restrictor 107. The flow restrictor 107 may be placed either upstream or downstream of the detector 108, and its function is to maintain an appropriate pressure upstream of the restrictor to ensure that fluid is maintained in a supercritical state in the column 103. The flow restrictor 107 may be a fixed capillary or nozzle or orifice of defined length and diameter, or a mechanically regulated constriction, orifice or nozzle that is used to control pressure in the column 103. Likewise the pump 101 may be used to control the pressure across the column. The column 103 is usually mounted inside an oven or heating element 104 that maintains the fluid in the flow path in a supercritical state. Typically, GC or LC ovens are employed. The analyte elutes from the column 103 into a detector 108. The detect 108 may be a flame ionisation detector (FID), a UV detector, photodiode array (PDA) or mass spectrometer (MS) or some other typical GC or LC detector. The detector 108 is typically placed upstream of the flow restrictor 107 if it is a UV, PDA, MS detector or other typical LC-type detector, and downstream if it is a FID or GC-type detector. The flow restrictor 107 or detector 108 then usually vents analyte and solvent to atmosphere at a vent or to a fraction collector 109.

Part of the theory of separation in SFC is based on the density of the supercritical fluid which corresponds to solvating power. As the pressure in the system is increased, the supercritical fluid density increases and correspondingly its solvating power increases. Therefore, as the density of the supercritical fluid mobile phase is increased, components retained in the column can be made to elute in order of the inverse solubility. This is similar to temperature programming in gas chromatography (GC) or using a solvent gradient in high performance liquid chromatography (HPLC). Supercritical fluid chromatography can most easily be described as a variant of either HPLC or GC where the major modification is the replacement of either the liquid or gas mobile phase with a supercritical fluid mobile phase. In general there are two hardware setups used: (a) An HPLC-like setup with two reciprocating pumps designed to provide a mixed mobile phase with a packed analytical column placed in an oven followed by an optical detector in which the pressure and flow rates can be independently controlled, (b) A GC-like setup with a syringe pump followed by a capillary column in a GC oven with a restrictor followed by a flame ionization detector, where the pressure is controlled by the flow rate of the pump.

With reference to FIG. 1, the mobile phase is initially pumped as a liquid and is brought into the supercritical region by heating it above its supercritical temperature before it enters the analytical column. It passes through an injection valve where the sample is introduced into the supercritical stream and then into the analytical column. For packed SFC, a typical LC injection valve is commonly used. In capillary SFC, small sample volumes must be quickly injected into the column and therefore pneumatically driven valves are used. It is maintained supercritical as it passes through the column and into the detector by a pressure restrictor placed either after the detector or at the end of the column. The restrictor allows the pressure to be controlled independently of the flow rate. The restrictor is a vital component as it keeps the mobile phase supercritical throughout the separation and often must be heated to prevent clogging; both variable and fixed restrictors are available. The most critical component in a modern SFC is the backpressure regulator or restrictor. This provides an additional control parameter—pressure. The restrictor is sometimes a pressure-adjustable diaphragm or controlled nozzle.

Although SFC instruments are similar to HPLC instruments, unlike HPLC an oven is generally used to provide temperature control of the column and a restrictor or back pressure regulator is used to maintain pressure in the column. The ovens used in SFC are generally conventional GC or LC ovens.

In contrast to HPLC pumping, pressure rather than flow control is necessary and pulseless operation is desirable. The type of high-pressure pump used is determined by the column type. For packed columns, reciprocating pumps are generally used while for capillary columns, syringe pumps are often used. Reciprocating pumps allow easy mixing of the mobile phase and introduction of modifier fluids. Syringe pumps provide consistent pressure for the mobile phase. The flow rate should be kept as constant as possible through the column. If the flow rate fluctuates, variations in the retention time of the injected sample would occur. Pumps are frequently cooled to maintain the supercritical fluid in a liquid state.

Once the sample is injected into the supercritical stream it is carried into the analytical column. The column contains a highly viscous liquid (called a stationary phase) into which the analytes can be temporarily adsorbed and then released based on their chemical nature. This temporary retention causes some analytes to remain longer in the column and is what allows the separation of the mixture. Different types of stationary phases are available with varying compositions and polarities. There are two types of analytical columns used in SFC, packed and capillary. Packed columns contain small deactivated particles to which the stationary phase adheres. The columns are conventionally stainless steel. Capillary columns are open tubular columns of narrow internal diameter made of fused silica, with the stationary phase bonded to the wall of the column

SFC is compatible with both HPLC and GC detectors. As a result, optical detectors, flame detectors, and spectroscopic detectors can be used. However, the mobile phase composition, column type, and flow rate must be taken into account when the detector is selected as they will determine which detector is able to be used. Some care must also be taken such that the detector components are capable of withstanding the high pressures of SFC. SFC may also be used with mass spectrometer (MS) detectors. Whereas flame ionisation detectors (FID) produce constant background noise in the presence of an organic modifier, MS does not.

Recent increases in solvent costs, acute solvent shortages and increased awareness of environmental factors have driven renewed interest in ‘green’ analytical technologies such as SFC. While macroscopic SFCs are available commercially, are greener, generate virtually no waste and use little or no solvent, and offer performance that is comparable if not superior to HPLCs, their size and cost is significant and may be limiting their uptake by users.

### BRIEF DESCRIPTION OF THE DRAWINGS

FIG. 1 shows the principal elements of a supercritical fluid chromatography system

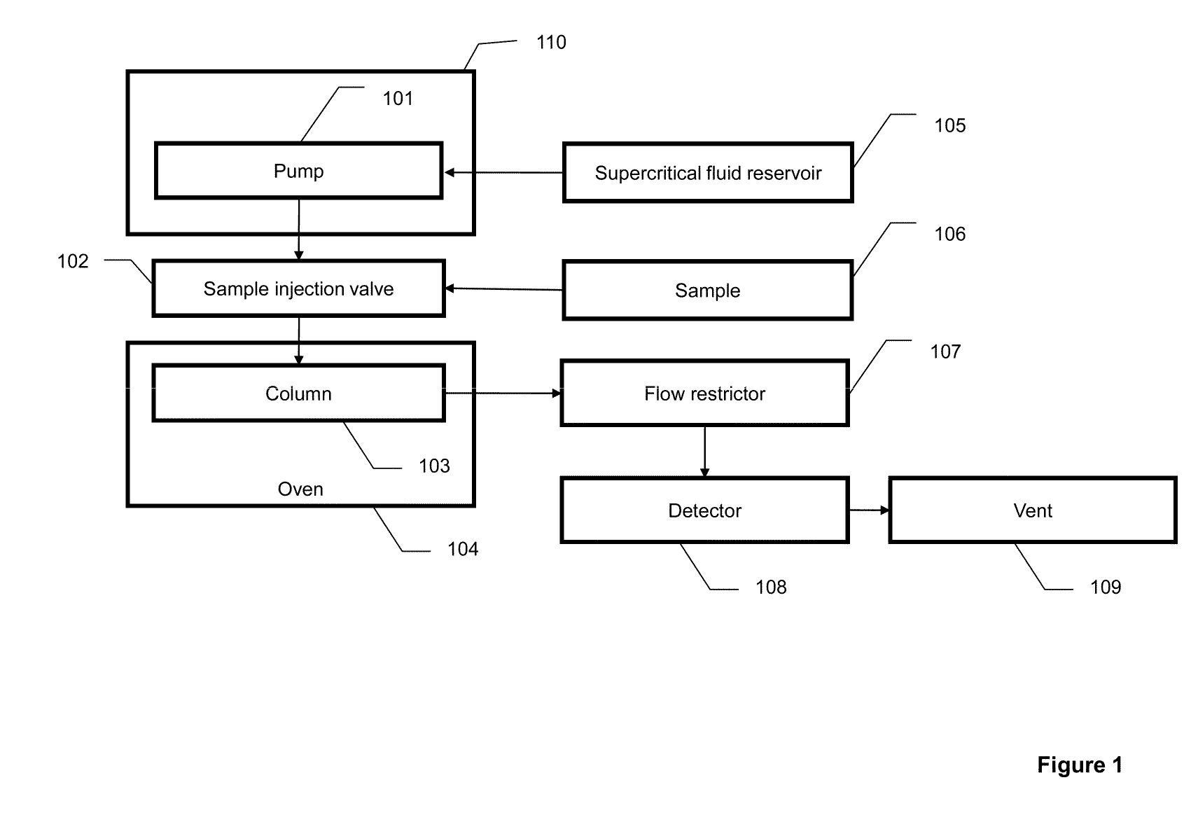

FIG. 2 is a schematic of the system of the invention showing a SFC system incorporating a microengineered column.

FIG. 3 is a schematic of a SFC system incorporating a microengineered column with an integrated flow split.

FIG. 4 is a schematic of a SFC system incorporating a microengineered column, also including an integrated flow split and flow restrictor.

FIG. 5 is a schematic of a SFC system incorporating a microengineered column,

wherein the sample injection valve, flow restrictor and flow split are integrated on the same device as the column.

FIG. 6 is a schematic of a SFC system incorporating a microengineered column,

wherein the sample injection valve, heating element, flow restrictor and flow split are integrated onto the same device as the column.

FIG. 7 is a schematic of a SFC system incorporating a microengineered column, wherein the sample injection valve, heating element, flow restrictor and flow split are monolithically integrated onto the same device as the column, and wherein the heating element also heats the sample injection valve, column, flow restrictor and flow split.

FIG. 8 illustrates the combinations of processes and materials for microfabrication of the chip of the SFC system.

### DETAILED DESCRIPTION OF THE INVENTION

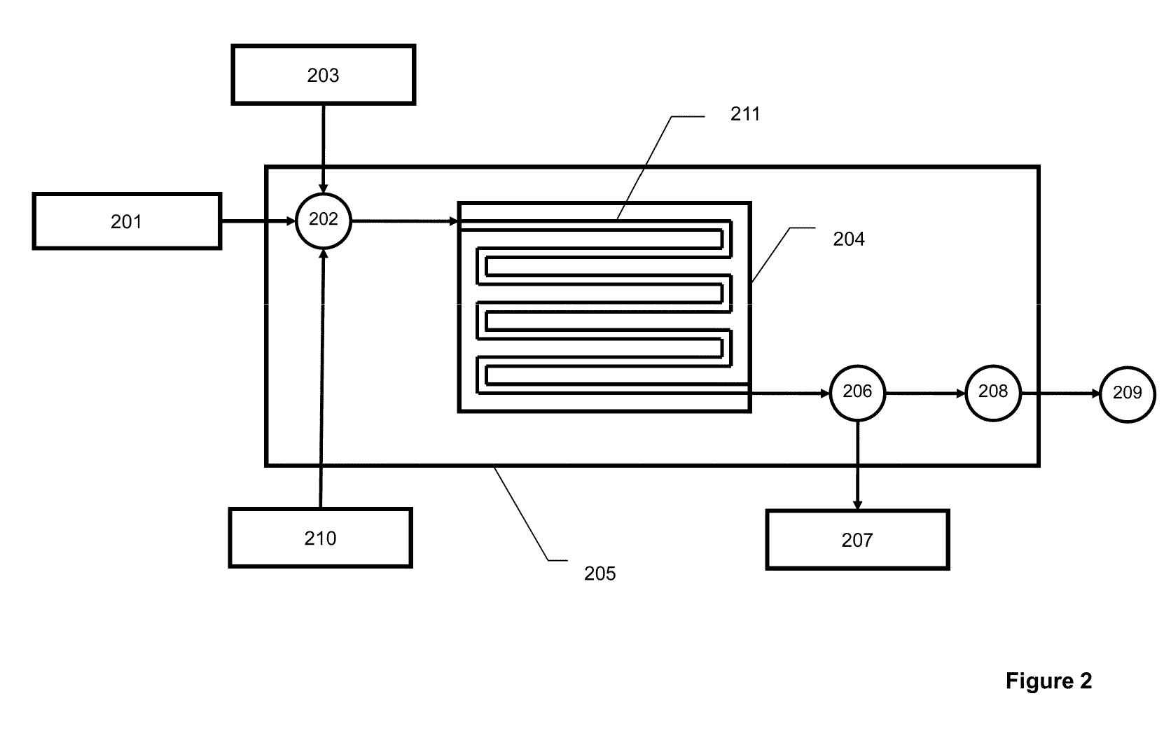

A detailed description of preferred exemplary embodiments of the invention is provided with reference to FIGS. 2 to 8.

FIG. 2 is a diagram showing an embodiment of the system of the invention. A pump 201 pressurises a reservoir compressible fluid so that it maintains a supercritical state along the flow path between the pump 201 and flow restrictor 208. The pump 201 may be a reciprocating or syringe pump, and the fluid may be CO₂ or some suitable cheap, non-toxic compressible fluid with a relatively low critical pressure and temperature. To maintain the fluid in a liquid state, the pump 201 may also incorporate some cooling element, such as Peltier stage in the case of a miniature pump. A valve 202 is used to inject a sample 203, preferably in solution, into the flow path and onto the column 204. An organic modifier 210 may also be added to the flow path to adjust the polarity of the solvent and to optimise the chromatographic conditions in the column 204. The valve 202 may incorporate a sample loop, or a pre-column, and may be a six-port valve of the type commonly used on LC or GC systems. A microchannel 211 forms a microengineered chromatographic column on chip 204 that coupled to the sample injection valve 202 such that the supercritical fluid flows along a flow path from the pump 201, through the valve 202 and onto the microengineered column. The microengineered SFC column is preferably formed from a microchannel 211 that is microfabricated onto a suitable substrate material such as silicon, glass, alumina, PYREX™ (which will be appreciated is a brand name for a type of borosilicate or soda-lime glass), polyamide or Polyether ether ketone (PEEK). The microfabricated channel 211 may be micromachined from the substrate of the chip 204 by means of one or a series of microfabrication processes such as photolithography, wet etching, laser ablation, metallization, electroplating, electroforming, deep reactive ion etching, patterning, ceramic firing, green tape ceramic, micro-injection moulding, electrical discharge machining and so on. In this way the microchannel may be considered as being formed on an upper surface of the substrate with the substrate defining a base and side walls of the microchannel. In order to seal the microchannel so as to allow the operable pressurizing of the microchannel it is desirable to also provide a roof on the microchannel. This roof or cap may be provided by a second substrate mounted relative to the first substrate to define a sandwich structure within which the microchannel is defined. In another arrangement the microchannel may be wholly fabricated or defined within a single substrate by for example etching through the substrate. In a further modification to that heretofore described the device may be fabricated in a three layer or substrate configuration. In such an arrangement first, second and third substrates may be provided and arranged relative to one another to define the microchannel. Such a configuration may typically comprise providing the second substrate between the first and third substrates. By suitably processing this second substrate it is possible to define what will ultimately provide side walls of the microchannel, top and bottom walls of the microchannel being provided by the first and third substrates on assembly of the device. The processing or patterning of the second substrate may provide for an etch process through the second substrate so as to define a grill type pattern resultant from a segmentation of the substrate material into distinct regions. Those portions of the substrate that are removed will typically ultimately define the location of the microchannel. An exemplary material that may be used for this second substrate is silicon in that it is relatively easy to process. Use of thin silicon, for example having a thickness of about 100 micrometres thick, is particularly advantageous for fabrication purposes. In such an arrangement the first and third substrates are typically fabricated from different materials to that of the second substrate-glass being an exemplary material. Entrances and exits to the microchannel may be provided through the first and third substrates or indeed by providing those as solid element and processing the second substrate to allow the operable introduction and exit of a fluid into the microchannel.

The microchannel 211 forms a monolithic chromatographic column that is sufficiently long as to adequately separate the components of complex mixtures. The length of the microchannel may vary dependent on the intended application. The microchannel may define a meander pattern within the substrate so as to provide for a longer length of column. It will be appreciated that the specifics of the meander pattern chosen will depend on the ultimate length of the path and it is not essential that the patter adopt that configuration shown in the exemplary figures referenced herein. The internal surfaces of the microchannel 211 may be coated with a suitable sorbent, or packed with a granular sorbent material, or both, so as to retain and elute analyte during chromatographic separation with acceptable resolution.

The microchannel 211 is desirably microfabricated from the substrate of the chip 204 to form a monolithic column with a very small surface area. The inverse relationship between column surface area and pressure scales favorably and this relationship permits the use of smaller, inexpensive pumps 201 such as syringe pumps or pneumatic pumps. The integrated chip 204 in this arrangement forms a discrete device that may be mounted within a heating element 205. The microchannel 211 is formed on a chip 204 that has sufficiently low thermal mass such that it may be efficiently heated, and rapidly cycled, by a miniature, low power heating element 205 permitting rapid temperature ramping of the chromatographic column to effect rapid separation. The heating element 205 may be an oven or a resistively heated material, wire or film. Once desorbed, eluent passes from the microengineered chip 204 through a flow splitter or valve 206 to a flow restrictor 208 and finally to a vent or fraction collector 209. It may be necessary to heat the valve 206 and flow restrictor 208 using heating element 205 in order to prevent clogging and to maintain supercritical fluid conditions along the flow path. A suitable liquid chromatography (LC) or gas chromatography (GC) detector 207 may be connected to the flow split or valve 206, upstream or downstream of the constriction 208 depending on the characteristics of the fluid necessary for efficient detection. The flow restrictor 208 may be fixed by design, or a variable constriction that is electronically or mechanically controlled. By virtue of the same scaling laws as the column, the flow restrictor 208 may also be microengineered in the same manner as the SFC chip 204, but microfabricated from a separate substrate and mounted discretely alongside the chip 204. If regulation is desired, the microengineered flow restrictor 208 may be electro-mechanically or piezo-electrically actuated by means of suitable miniature actuators. Similarly, the valve or split 206 may also be microfabricated as channels formed from a suitable substrate and microengineered into a discrete device that is likewise mounted in the flow path. The sample injection valve 202, chip 204, flow split 206 and flow restrictor 208 may all be discretely mounted on a common sub-mount, such as a printed circuit board, inside a common heating element 205.

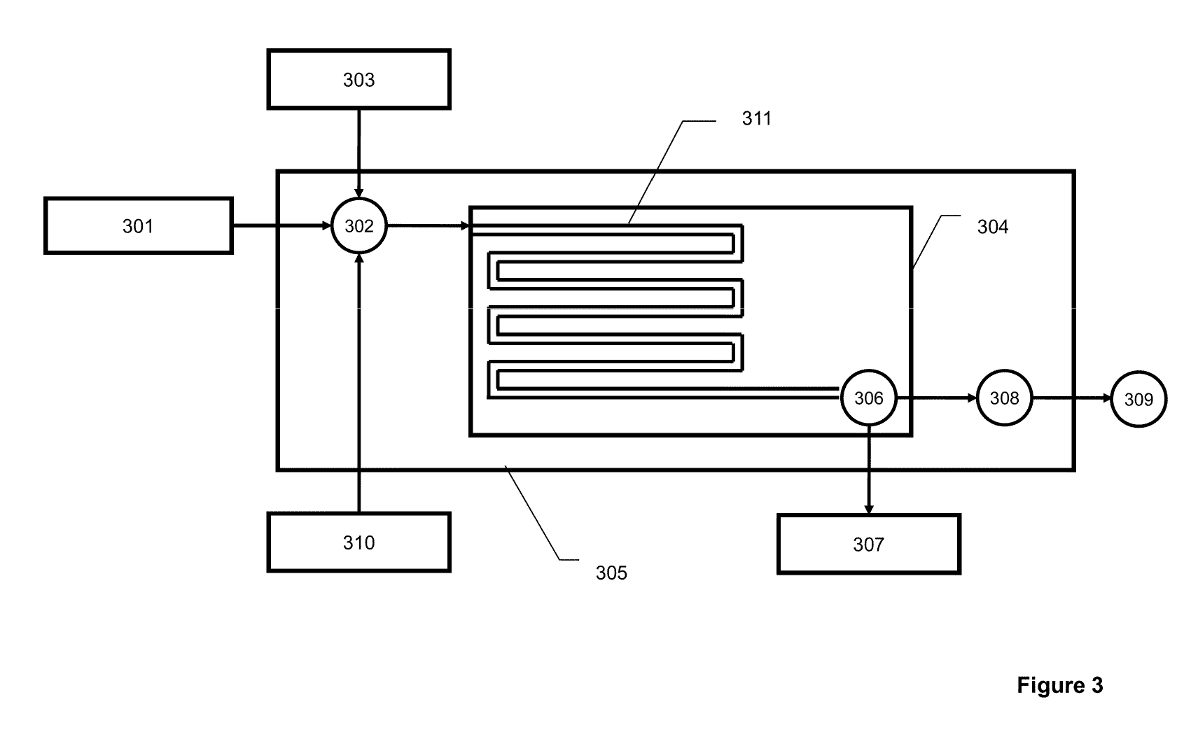

FIG. 3 is a schematic describing another embodiment of the microengineered SFC device of the invention. As before, a pump 301 pressurizes a reservoir of fluid so that it is supercritical along the flow path between the pump 301 and the flow restrictor 308. The pump 301 is coupled to a sample injection valve 302 which in turn fluidically couples a sample 303 and, if desirable, an organic modifier 310 with a microchannel 311. A chromatographic column is formed from microchannel 311 microfabricated from a suitable substrate of the chip component 304. In FIG. 3, the chip 304 also integrates a flow split or valve 306 so that the microchannel 311 of the column are fluidically coupled to the flow split 306 without the need for separate connectors, unions or capillaries. The elimination of discrete connectors, unions or capillaries from the flow path between the column channels 311 and the valve 306 minimises dead volumes, eliminates user intervention and enhances chromatographic separation. The valve 306 and the microengineered channels 311 may be monolithically integrated onto from the same substrate as a chip 304. The column channels 311 may be packed or coated or both with a suitable sorbent material that retains analyte such as C18, Luna or PDMS. The chip 304 is fluidically coupled to a flow restrictor 308, a detector 307 and a vent or fraction collector 309. The chip 304, sample injection valve 302 and flow restrictor 308 are all mounted inside a heated element 305. The pump 301 may be cooled. The sample injection valve 302 may be a six-port valve that may include a sample loop. The sample injection valve 302 and flow split 308 may be microengineered devices that are micromachined from suitable substrates as separate devices that are discretely mounted alongside chip 304 on a sub-mount such as a printed circuit board inside heating element 305.

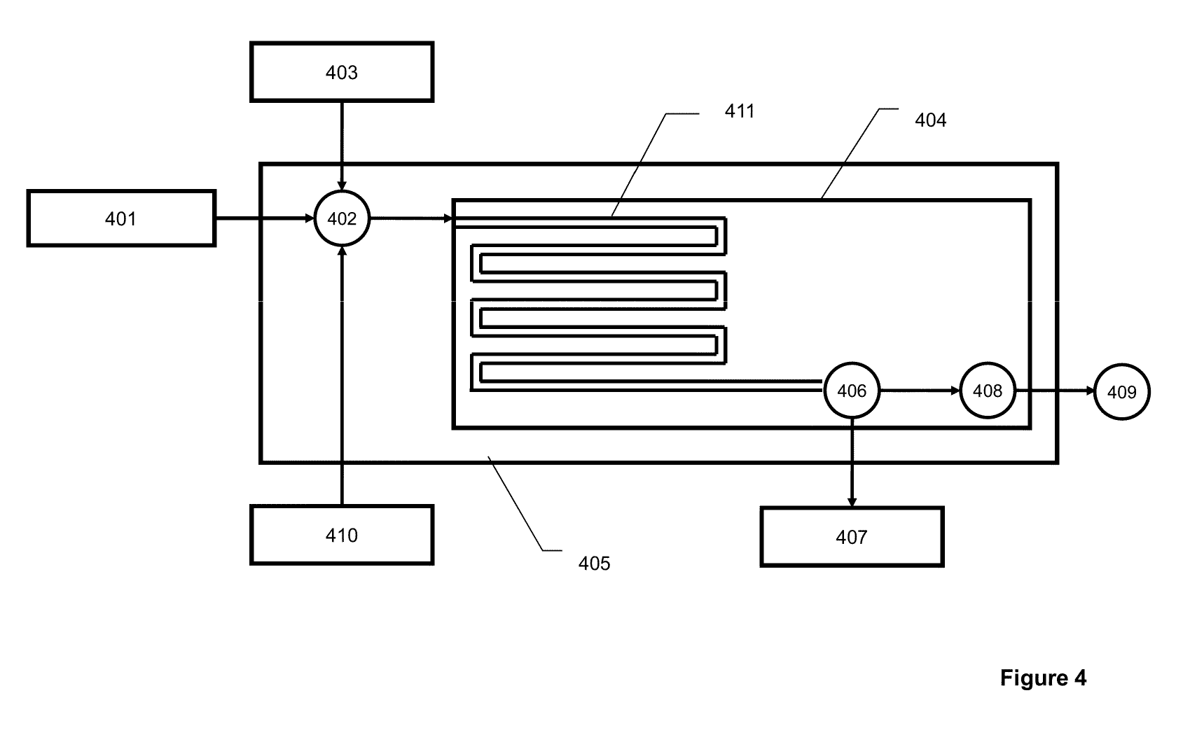

FIG. 4 shows another embodiment of the microengineered SFC component of the invention. As above, a pump 401 pressurizes a reservoir of fluid so that is supercritical along the flow path between the pump 401 and the flow restrictor 408. The pump 401 is coupled to a sample injection valve 402 which in turn fluidically couples a sample reservoir or sample injection port 403 and, if desirable, an organic modifier reservoir 410 with the microchannel 411 of the chromatographic column. A chromatographic column is formed from microchannel 411 microfabricated from a suitable substrate of the chip component 404. In FIG. 4, the chip 404 also monolithically integrates a flow split, or valve, 406 and a flow restrictor 408 so that the microchannel 411 of the chromatographic column are fluidically coupled to the flow split 406 and restrictor 408 without the need for separate connectors, unions or capillaries. The elimination of discrete connectors, unions or capillaries from the flow path between the microchannel 411, the valve 406 and the flow restrictor 408 minimises dead volumes, eliminates user intervention and enhances chromatographic separation. The resistance of the integrated restrictor 408 may be fixed based on orifice diameter or a converging length of micromachined channel length or both. Alternatively, the integrated restrictor 408 may be based on a mechanically variable constriction or nozzle which is actuated by means of miniature electromechanical, piezoelectric or thermo-elastic actuators. In a preferred embodiment the microengineered flow restrictor 408 is formed by a capillary or micro-channel that is throttled by a miniature piezoelectric actuator which, due to an applied electrical signal, expands and constricts the flow path. In this way a flow restrictor 408 may be implemented so that it electrically regulates the pressure across the chip column 404. The valve 406, the flow restrictor 408 and the microchannel 411 may be monolithically integrated onto the same substrate as a chip 404. The microchannel 411 of the column may be packed or coated or both with a suitable sorbent material that retains analyte such as C18, Luna or PDMS. The chip 404 is fluidically coupled to a detector 407 and a vent or fraction collector 409 via flow splitter 406. The chip 404 and sample injection valve 402 are all mounted inside a heated element 405. The pump 401 may be cooled. The sample injection valve 402 may be a six-port valve that may include a sample loop. The sample valve 402 and flow split 408 may be microengineered devices that are micro-machined from suitable substrates into devices that are discretely mounted alongside chip 404 on a common sub-mount, such as a printed circuit board, inside the heating element 405.

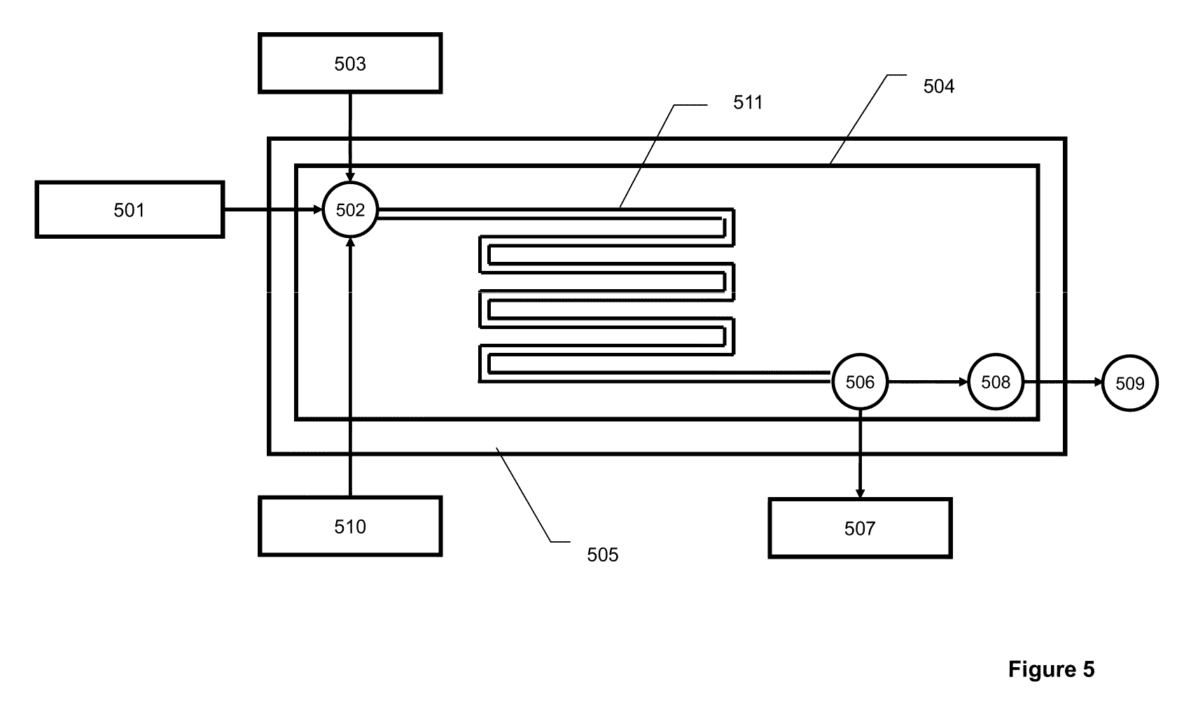

FIG. 5 shows an alternative embodiment of the microengineered SFC component of the invention. As above, a pump 501 pressurizes a reservoir of fluid so that it is supercritical along the flow path and across the column channel 511. The pump 501 is coupled to a sample injection valve 502 which in turn couples a sample reservoir or sample injection port 503 and, if desirable, an organic modifier 510 with a microchannel 511. A chromatographic column is formed from microchannel 511 microfabricated from a suitable substrate of the chip component 504. In FIG. 5, the chip component 504 also integrates a sample injection valve 502 with the microchannel 511, a flow split (or valve) 506 and a flow restrictor 508 so that the microchannel 511 forming the chromatographic column is fluidically coupled to the sample injection valve 502, flow split 506 and restrictor 508 without the need for separate connectors, unions or capillaries. The elimination of discrete connectors, unions or capillaries from the flow path between the pump and flow restrictor 508 minimises dead volumes, eliminates user intervention and enhances chromatographic separation. The resistance of the integrated restrictor 508 may be fixed based on orifice diameter or a converging length of micromachined channel length, or both. Alternatively, the integrated restrictor 508 may be based on a mechanically variable constriction or nozzle which is actuated by means of miniature electromechanical, piezoelectric or thermo-elastic actuators. In a preferred embodiment the microengineered flow restrictor 508 is formed from a capillary or microchannel that is throttled by a miniature piezoelectric actuator which, due to an applied electrical signal, expands and constricts the flow path. In this way a flow restrictor 508 may be microengineered so that it electrically regulates the pressure across the microchannel of the chromatographic column 511. The sample injection valve 502, the flow splitter 506, the flow restrictor 508 and the microfabricated channels 511 of the chromatographic column may be monolithically integrated onto the same substrate forming the SFC chip component 504. The column channels 511 may be packed or coated or both with a suitable sorbent material that retains analyte such as C18, Luna or PDMS. The SFC chip 504 is fluidically coupled to a detector 507 and a vent or fraction collector 509. The chip 504 is mounted inside a heated element 505 to effect temperature ramping of the column and to free restrictor 508 and valves 502 and 506 from clogging. The pump 501 may be cooled. The sample injection valve 502 may be a six-port valve that may include a sample loop. The chip 504 may be mounted on a sub-mount, such as a printed circuit board, inside a heating element 505.

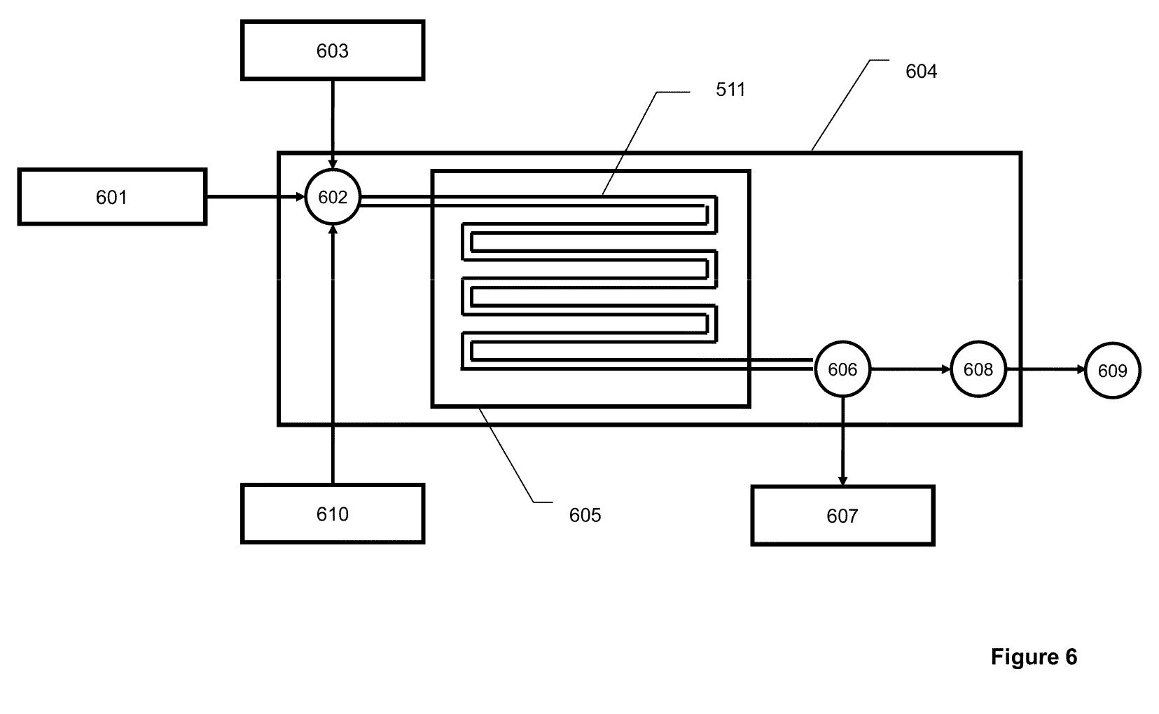

FIG. 6 shows a further embodiment of the microengineered SFC component of the invention. As above, a pump 601 pressurizes a reservoir of fluid so that it is supercritical along the flow path and across the microchannel 611 of the column. The pump 601 is coupled to a sample injection valve 602 which in turn couples a sample reservoir or sample injection port 603 and, if desirable, an organic modifier reservoir 610 with a microchannel 611. A chromatographic column is formed from microchannel 611 microfabricated from a suitable substrate on a chip component 604. In FIG. 6, the chip component 604 also integrates a sample injection valve 602 with the microchannel 611, a flow split (or valve) 606 and a flow restrictor 608 so that the microchannel 611 of the chromatographic column is fluidically coupled to the sample injection valve 602, flow split 606 and restrictor 608 without the need for separate connectors, unions or capillaries. The elimination of discrete connectors, unions or capillaries from the flow path between the pump and flow restrictor 608 minimises dead volumes, eliminates user intervention and enhances chromatographic separation. The resistance of the integrated restrictor 608 may be fixed based on orifice diameter or a converging length of micromachined channel length, or both. Alternatively, the integrated restrictor 608 may be based on a mechanically variable constriction or nozzle which is actuated by means of miniature electromechanical, piezoelectric or thermo-elastic actuators. In a preferred embodiment the microengineered flow restrictor 508 is formed from a capillary or microchannel that is throttled by a miniature piezoelectric actuator which, due to an applied electrical signal, expands and constricts the flow path. In this way a flow restrictor 608 may be microengineered so that it electrically regulates the pressure across the microchannel of the chromatographic column 611. The sample injection valve 602, the valve 606, the flow restrictor 608 and the microfabricated channels 611 may be monolithically integrated onto the same substrate as a SFC chip component 604. The column channels 611 may be packed or coated or both with a suitable sorbent material that retains analyte such as C18, Luna or PDMS. The SFC chip 604 is fluidically coupled to a detector 607 and a vent or fraction collector 609. The chip 604 integrates a heated element 605 in order to effect rapid temperature ramping of the column and to maintain the fluid in a supercritical state inside the column. The heating element 605 may be a resistively heated film or layer that is microfabricated onto the substrate of the chip 604. The pump 601 may be cooled. The sample injection valve 602 may be a six-port valve that may include a sample loop. The chip 604 may be mounted on a sub-mount, such as a printed circuit board.

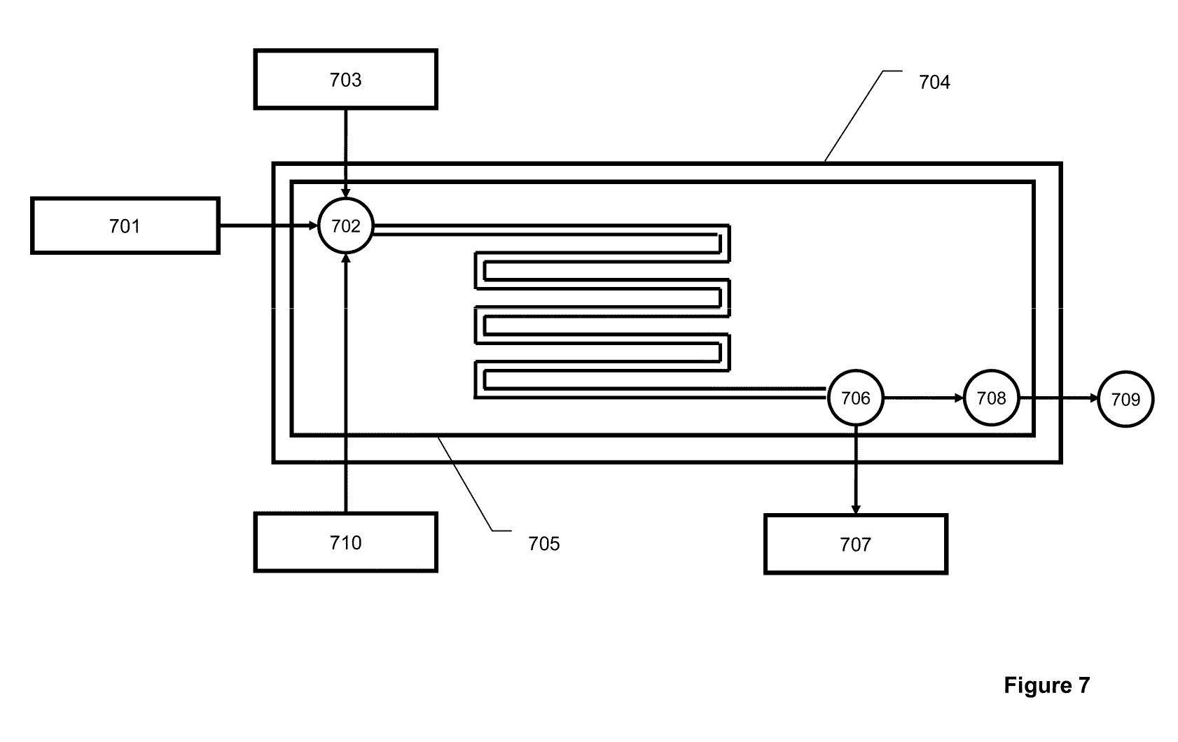

FIG. 7 shows another embodiment of the microengineered SFC component of the invention. As above, a pump 701 pressurizes a reservoir of fluid so that it is supercritical along the flow path and across the microchannel 711 of the column. The pump 701 is coupled to a sample injection valve 702 which in turn couples a sample reservoir or sample injection port 703 and, if desirable, an organic modifier reservoir 710 with a microchannel 711. A chromatographic column is formed from a microchannel 711 microfabricated from a suitable substrate on a chip component 704. In FIG. 7, the chip component 704 also integrates a sample injection valve 702 with the microchannel 711, a flow split (or valve) 706 and a flow restrictor 708 so that the microchannel 711 of the chromatographic column is fluidically coupled to the sample injection valve 702, flow split 706 and restrictor 708 without the need for separate connectors, unions or capillaries. The elimination of discrete connectors, unions or capillaries from the flow path between the pump and flow restrictor 708 minimises dead volumes, eliminates user intervention and enhances chromatographic separation. The resistance of the integrated restrictor 708 may be fixed based on orifice diameter or a converging length of micromachined channel length, or both. Alternatively, the integrated restrictor 708 may be based on a mechanically variable constriction or nozzle which is actuated by means of miniature electromechanical, piezoelectric or thermo-elastic actuators. In a preferred embodiment the microengineered flow restrictor 708 is formed from a capillary or microchannel that is throttled by a miniature piezoelectric actuator which, due to an applied electrical signal, expands and constricts the flow path. In this way a flow restrictor 708 may be microengineered so that it electrically regulates the pressure across the microchannel of the chromatographic column 711. The sample injection valve 702, the valve 706, the flow restrictor 708 and the microfabricated channels 711 may be monolithically integrated onto the same substrate as a SFC chip component 704. The column channels 711 may be packed or coated or both with a suitable sorbent material that retains analyte such as C18, Luna or Polydimethylsiloxane (PDMS). The SFC chip 704 is fluidically coupled to a detector 707 and a vent or fraction collector 709 via integrated splitter or valve 706. The chip 704 integrates a heated element 705 in order to effect rapid temperature ramping of the column and heating of sample injection valve 702, flow splitter 706 and flow restrictor 708 to prevent clogging, and to maintain the fluid in a supercritical state along the flow path between pump 701 and vent 709. The heating element 705 may be a resistively heated film or layer that is microfabricated onto the substrate of the chip 704. The pump 701 may be cooled. The sample injection valve 702 may be a six-port valve that may include a sample loop. The chip 704 may be mounted on a sub-mount, such as a printed circuit board, forming an integrated SFC device.

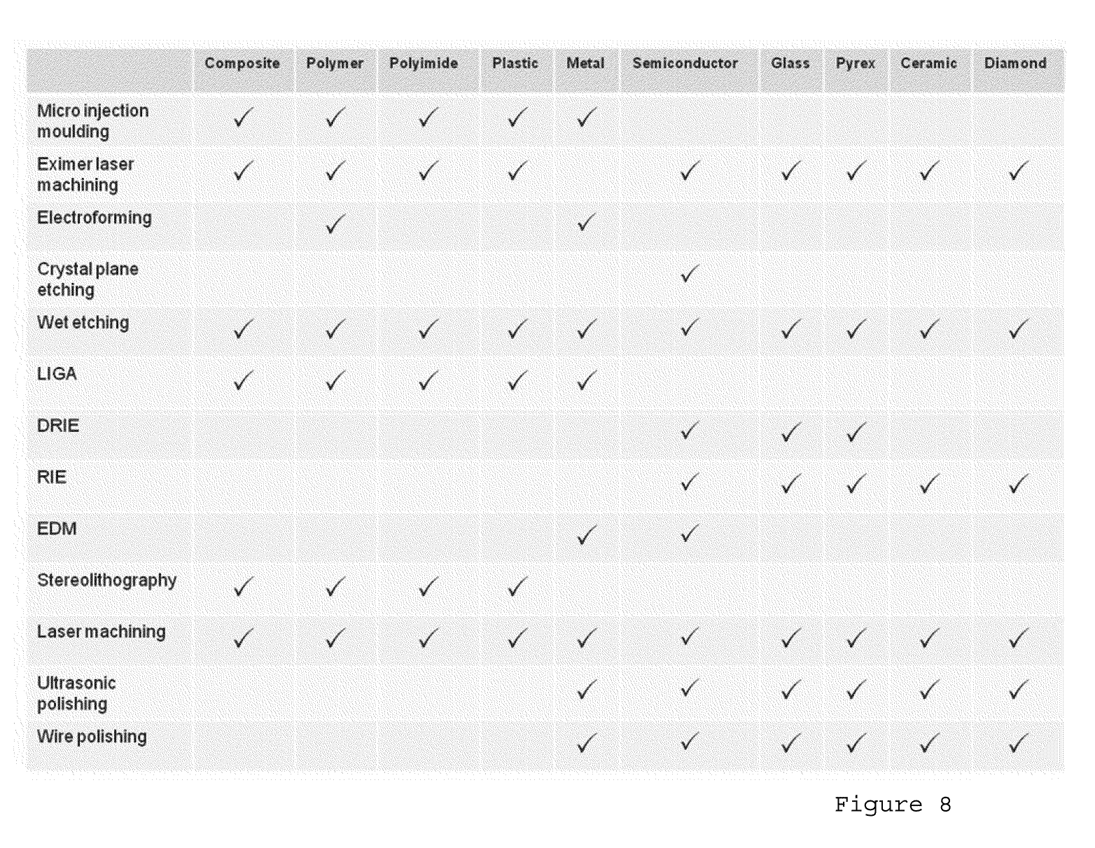

The microchannel 211 forming the chromatographic column of the chip 204 is the critical component of the SFC system of the invention. In one embodiment, the chip 204 can microfabricated using the combinations of the processes and materials represented by the hatched regions in FIG. 8. Those hatched regions on FIG. 8 represent all possible machining techniques for the materials listed. The materials are composite materials (including conductive polymers), polymer, polyimide, Su8, semiconductor materials, glass, Pyrex and ceramic. The processes listed are micro-injection moulding, excimer laser machining, electroforming, crystal plane etching, wet etching, LIGA, Deep Reactive Ion Etching, Reactive Ion Etching, Electrical Discharge Machining, Stereo-lithography and laser machining. It will be understood that LIGA is a German acronym for Lithographie, Galvanoformung, Abformung (Lithography, Electroplating, and Molding) that describes a fabrication technology used to create high-aspect-ratio microstructures. SU8 is a commonly used epoxy-based negative photoresist and is a polymer.

Likewise, the sample injection valve 202, flow splitter 206 and flow restrictor 208 may be microfabricated using some combination of these processes and materials into discrete devices that may be subsequently fluidically coupled with the chip 204 to form a microengineered SFC system.

It will be understood that what has been described herein is an exemplary arrangement of a miniature SFC system that advantageously employs the benefits associated with SFC performance such as those defined in terms of the speed of separation and chromatographic retention times. As explained above, pressure is a key control parameter and performs a similar function to gradient or column temperature ramp in a LC or GC respectively. Pressure may be controlled from the pump, or by a flow restrictor, or both. Typically, in prior art arrangements the SFC pumps are large and expensive units that require heavy cooling mechanisms. However in accordance with the present teaching a smaller SFC system may be provided which allows for use with smaller, cheaper and simpler pumps than heretofore possible.

By micro-engineering the column it is possible to reduce the surface area of the column and provide one or more target analyte coatings specific to the intended analysis application on that column surface, while maximizing the chromatographic performance. Similarly such miniaturisation provides for minimisation of dead volumes which advantageously prevents dispersion or changes in pressure or flow rate along the flow path. To reduce cycle times, the heated element has been described as having a low thermal mass. Components such as valves, restrictors and columns with low thermal mass have been described as being advantageously operably rapidly heated using small ovens or miniature or integrated heating elements. Likewise, low thermal mass permits efficient cooling of fluids to a temperature where they are in a liquid phase. Also, to simplify cooling and permit use of small, standard Peltier cooling stages for example, less massive columns and components with lower thermal mass have been described.

By micro-engineering and integrating these components onto a substrate or several substrates the present teaching provides for minimisation of surface area, dead volume and thermal mass permitting the use of small, simple and cheap pumps and cooling stages, thereby reducing the overall size and cost of ownership of a SFC system.

It will be appreciated that what has been described herein are exemplary arrangements of a microengineered SFC system for rapidly and efficiently separating the constituents of a complex mixture. The SFC system includes a microchannel that is microfabricated from a suitable substrate so that it forms a chromatographic column for separation of chemicals. The surface area of the microchannel of the column is sufficiently small as to permit use of miniature and relatively inexpensive pumps, and the thermal mass of the microengineered column is sufficiently low as to permit rapid temperature cycling using a miniature, low power and inexpensive heating element. At least a portion of this microchannel is packed with suitable sorbent materials or includes surfaces which are suitably coated with sorbent, or both, so as to retain and elute analyte under certain conditions. As a result analyte passing within this microchannel undergoes chromatographic separation.

While the invention has been described with reference to different arrangements or configurations it will be appreciated that these are provided to assist in an understanding of the teaching of the invention and it is not intended to limit the scope of the invention to any specific arrangement or embodiment described herein. Modifications can be made to that described herein without departing from the spirit or scope of the teaching of the present invention. Furthermore where certain integers or components are described with reference to any one figure or embodiment it will be understood that these could be replaced or interchanged with those of another figure—or indeed by elements not described herein—without departing from the teaching of the invention. The present invention is only to be construed as limited only insofar as is deemed necessary in the light of the appended claims.

The words comprises/comprising when used in this specification are to specify the presence of stated features, integers, steps or components but does not preclude the presence or addition of one or more other features, integers, steps, components or groups thereof.

What is claimed is:

1. A microengineered supercritical fluid chromatography device for operably effecting a separation of components of complex mixtures, the device comprising a substrate defining a fluid path having:
a. an inlet for receiving a fluid;
b. an integrated microchannel forming a monolithic chromatographic column through which the fluid may flow; and,
the device further comprising a microfabricated flow restrictor downstream of the microchannel to operably maintain the fluid in a supercritical state while within the microchannel.

2. The device of claim 1 wherein surfaces of the microchannel are coated with a sorbent material or packed with a granular sorbent material, or both, so as to operably retain and elute analyte during chromatographic separation.

3. The device of claim 1 wherein the substrate is formed from one or more of: semiconductor materials, glass, alumina, borosilicate or soda-lime glass, quartz, polyimide, su8 or PEEK, composite materials, including conductive polymers, polymer, or ceramic materials.

4. The device of claim 1 wherein the microchannel defines a meander pattern.

5. The device of claim 1 wherein the microchannel is defined within the substrate.

6. The device of claim 1 wherein the microchannel is defined in an upper surface of the substrate, the substrate providing a base and side walls of the microchannel

7. The device of claim 6 comprising a second substrate, the first and second substrate co-operating to define the microchannel therebetween.

8. The device of claim 6 wherein the second substrate is provided relative to the first substrate so as to cap the microchannel.

9. The device of claim 7 wherein the first and second substrates co-operate to form a sandwich structure.

10. The device of claim 7 wherein the second substrate is formed from a different material to the first substrate.

11. The device of claim 1 wherein the device comprises first, second and third substrates arranged relative to one another to define the microchannel.

12. The device of claim 11 wherein the second substrate is provided between the first and third substrates.

13. The device of claim 12 wherein the second substrate is processed such that it defines side walls of the microchannel, top and bottom walls of the microchannel being provided by the first and third substrates.

14. The device of claim 11 wherein the second substrate is fabricated from a semiconductor materials or a composite material, including conductive polymers, or polymer, polyimide, BoPET (Biaxially-oriented polyethylene terephthalate), Su8, PEEK, glass, borosilicate or soda-lime glass, and ceramic.

15. The device of claim 11 wherein the first and third substrates are fabricated from different materials to that of the second substrate.

16. The device of claim 1 wherein the microchannel defines a fixed volume within which the pressure of a fluid operably flowing therethrough may be controlled.

17. The device of claim 1 wherein the flow restrictor is defined by a variation in the cross sectional area of the fluid path, the variation operably restricting flow of the fluid therethrough.

18. The device of claim 1 wherein flow restrictor provides a variable variation, the restrictor being operably mechanically or electronically actuated to effect the variation.

19. The device of claim 1 wherein the flow restrictor is provided as a capillary or microchannel that is throttled by an actuator which effects a expansion or constriction of the flow path through the restrictor.

20. The device of claim 19 wherein the actuator is actuated by application of an electrical signal.

21. The device of claim 1 wherein the flow restrictor comprises a heatable element which on heating varies the viscosity of the fluid within the flow restrictor so as to operably regulate the pressure of the fluid and maintain the fluid in a supercritical state while within the microchannel.

22. The device of claim 21 wherein the heatable element of the flow restrictor is resistively heated.

23. A supercritical fluid chromatography system comprising a microengineered supercritical fluid chromatography device for operably effecting a separation of components of complex mixtures, the device comprising a substrate defining a fluid path having:
a. an inlet for receiving a fluid;
b. an integrated microchannel forming a monolithic chromatographic column through which the fluid may flow; and
the device further comprising a microfabricated flow restrictor downstream of the microchannel to operably maintain the fluid in a supercritical state while within the microchannel, the system further comprising:
a fluid source;
a pump; and
wherein the pump is configured to effect a transfer of fluid from the fluid source to the microchannel and cooperates with the flow restrictor to regulate the pressure within the microchannel so as to operably maintain the fluid in a supercritical state while within the microchannel.

24. The system of claim 23 further comprising a sample injector in fluid communication with the microchannel so as to operably allow for the introduction of a sample into the microchannel.

25. The system of claim 23 further comprising a heating element, the heating element being provided relative to the device to operably effect a heating of the microchannel.

26. The system of claim 23 comprising a cooling element, the cooling element being configured to effect a cooling of the pump so as to operably maintain the fluid in a supercritical state.

27. The system of claim 24 wherein the sample injector is in fluid communication with an organic modifier reservoir and is configured to operably provide an infusion of an organic modifier from the reservoir into the column to adjust the polarity of the fluid.

28. The system of claim 25 wherein the heating element defines a volume within which at least a portion of the microchannel is received.

29. The system of claim 23 further comprising a detector.

30. The system of claim 29 wherein the detector is selected from a flame ionisation detector, a UV detector, a photodiode array or a mass spectrometer.

31. The system of claim 29 wherein the detector is provided relative to the microchannel such that a sample operably elutes from the microchannel and into the detector.

32. The system of claim 28 wherein the detector is provided upstream of the flow restrictor.

33. The system of claim 28 wherein the detector is provided downstream of the flow restrictor.

34. The system of claim 29 wherein the flow restrictor or detector is configured to effect a venting of analyte or solvent to the atmosphere.

35. The system of claim 25 wherein the heating element is an oven or a resistively heated material, wire or film.

36. The system of claim 23 wherein the sample injector comprises a sample loop or pre-column.

37. The system of claim 23 wherein one or more of the:
a. fluid source,
b. pump,
c. sample injector,
d. heating element,
e. cooling element, and
f. flow restrictor,
are formed as discrete devices microfabricated from separate substrates.

38. The system of claim 23 wherein one or more of the:
a. fluid source,
b. pump,
c. sample injector,
d. heating element,
e. cooling element, and
f. flow restrictor,
are monolithically integrated on a common substrate.

39. The system of claim 38 wherein the heating element is integrated onto the common substrate so as to operably effect a conductive heating of other components commonly located on the common substrate.

40. The system of claim 23 wherein the device is provided on a sub-mount prior to incorporation into the system.

41. The system of claim 40 wherein the sub-mount provides for relative mounting of one or more of the components of the system.

42. A method of fabricating a supercritical fluid chromatography device, the method comprising:
a. microfabricating a fluid path within a substrate;
b. defining a microchannel within the fluid path;
c. defining a flow restrictor downstream of the microchannel, the flow restrictor operably maintaining a fluid in a supercritical state while within the microchannel; and
wherein the substrate is selected from one of: composite materials, including conductive polymers, polymer, polyimide, Su8, PEEK, semiconductor materials, glass, borosilicate or soda-lime glass, and ceramic.

43. The method of claim 42 wherein the method includes the use of techniques selected from micro-injection moulding, excimer laser machining, electroforming, crystal plane etching, wet etching, LIGA, Deep Reactive Ion Etching, Reactive Ion Etching, Electrical Discharge Machining, Stereo-lithography and laser machining.
